(19) United States
(12) Patent Application Publication
(10) Pub. No.: US 2011/0148577 A1
(43) Pub. Date: Jun. 23, 2011

(54) CONTROLLING A STRIKING MEANS FOR A BELL

(76) Inventor: Klaus Wolter, Dusseldorf (DE)

(21) Appl. No.: 12/737,522

(22) PCT Filed: Jul. 21, 2009
(86) PCT No.: PCT/EP2009/059366

§ 371 Date: Mar. 4, 2011

(30) Foreign Application Priority Data
Jul. 24, 2008 (DE) 10 2008 034 760.4

(51) Int. Cl. G08B 3/10

(52) U.S. Cl. 340/6.1

(57) ABSTRACT

To improve the striking of a bell, first of all a signal is registered. An actuator is then induced, by means of a signal generated following the registered signal, to transfer the striking means into a predefined starting state.

The invention relates to a method, a device and a computer program for controlling a striking means for a bell.

Bells are usually struck by striking means such as clappers or hammers in order to produce a tonal sound.

In some embodiments, the striking means returns to the same spatial state of rest after each strike of the bell unless it has been previously induced to strike the bell again. In this respect, the state of rest is usually determined by gravity. However, it can also be determined by a spring, a rubber band or a magnet.

In other embodiments, there is no clearly defined spatial state of rest of the striking means, for example if the striking means is moved horizontally on a slide rail or if the striking means is rotated about its mass centre in order to strike the bell.

The object of the invention is to improve the striking of a bell.

A method for controlling a striking means for a bell is proposed. The method comprises the registration of a signal. The method further comprises the inducement of an actuator by means of a signal generated following the registered signal to transfer the striking means into a predefined starting state.

A device with processing equipment is also proposed. The processing equipment is configured to register a signal and to induce an actuator by means of a signal generated following the registered signal to transfer a striking means for a bell into a predefined starting state.

Furthermore, a computer program is proposed for controlling a striking means for a bell. The computer program is configured to induce a processor to carry out the proposed method when the computer program is executed by the processor.

A computer program product is also proposed which comprises a computer-readable medium in which a corresponding computer program is stored or implemented. The computer program product can be, for example a CD ROM, a memory stick or a hard disc for a computer, but also any other product with a storage medium which can be read out by a computer.

The invention is based on the consideration that precisely reproducible and thus exactly controllable sound events can only be achieved when a sound exciter is actuated in each case from exactly the same spatial starting state with respect to a bell in order to strike the bell. It is therefore proposed to induce an active transfer of the striking means into a predefined starting state. The transfer is active because it is induced on the basis of a registered signal and by means of a generated signal. In this respect, the two signals can be of any type, for example electrical, optical or mechanical.

Thus, the invention has the advantage that an exact reproducibility of a sound event can be guaranteed. Compared to a passive return, the proposed active return can be performed more rapidly. In particular, if the bell is to be struck a number of times in succession, a complete return is otherwise often impossible.

Furthermore, new striking possibilities are provided which cannot be realised without a return of the striking means.

The striking means can be any sound exciter by which a bell can be struck, for example a clapper, a hammer or a dumbbell-shaped exciter with two weights on the opposing ends of a stem.

The striking means can be transferred into the predefined starting state in different ways. Thus, for example in each case before a strike it can initially be transferred into the starting state. Alternatively, it can be held permanently in an active manner in the starting state, interrupted only by a respective striking procedure. As another alternative, the striking means can be transferred into the predefined starting state in each case after a strike. The latter alternative is a possibility in particular if the predetermined starting state is a stable state, whether due to gravity or due to a passive mechanical holding means.

In an exemplary embodiment, the registered signal comprises a signal for striking the bell by the striking means. Such a signal can be initiated, for example by a user or by data processing equipment. Before the bell is struck by the striking means, the actuator can be induced to transfer the striking means into the predefined starting state. The processing equipment can be configured in terms of device to initiate this.

In another exemplary embodiment, the registered signal comprises a signal output by a sensor. This signal indicates that an ongoing state of the striking means is different from the predefined starting state.

In an exemplary embodiment, the signal from a sensor is registered in each case after the bell has been struck by the striking means.

In an exemplary embodiment, the registered signal of a sensor is delivered to a control circuit controlling the actuator. The control circuit permanently induces the actuator to keep the striking means in the predefined starting state. In this case, the control circuit is interrupted in each case by a signal to strike the bell by the striking means. Thus, here, the striking means is constantly ready in the predefined starting state so that there is no delay when a strike is due. At the same time, it is not necessary for the predefined starting state to be a stable state for the striking means. In terms of device, the control circuit can be implemented in the processing equipment.

A wide variety of sensors are possible as sensor for outputting the signal to the processing equipment. An optical or mechanical displacement pickup as a sensor can detect, for example, how far the striking means or a specific part of the striking means must be moved in order to transfer the striking means into the predefined starting state and can emit a corresponding signal. An optical or mechanical angle transducer as a sensor can detect, for example, whether a current deflection of a striking means is consistent with a deflection corresponding to the predefined starting state, and can emit a corresponding signal. In addition, such an angle transducer can indicate the angle by which the deflection must be changed in order to transfer the striking means into the predefined starting state. A microphone, a transducer for detecting vibrations or a pressure measuring device as a sensor can indicate, for example, a completed strike of the bell, after which the striking means is to be transferred into the predefined starting state. A switch or a light barrier as sensor can establish whether the striking means is in the predefined starting state, for example if only then a beam of light is interrupted or a switch is opened. A large number of other sensors are likewise considered, such as a piezoelectric transducer, a magnetic sensor, a capacitive-electric transducer or an optical transducer.

To transfer the striking means into the predefined starting state, the same actuator can be used as is used to move the striking means to strike the bell. As an alternative, however, an individual actuator can also be provided for transferring the striking means into the predefined starting state.

The proposed device can have different further components. Examples include the striking means and/or the bell and/or the actuator. Furthermore, the device can comprise a user interface which provides the processing equipment with signals in respect of a desired striking of the bell, and/or a sensor for outputting a signal to the processing equipment. In addition, the device can have not just one bell, but also a plurality of bells, for example in the form of a carillon. In this case, each bell can be provided with its own striking means, its own actuator and its own processing equipment, its own user interface and optionally its own sensor. Alternatively, a striking means and/or an actuator and/or processing equipment and/or a user interface and/or a sensor can also be provided jointly for a plurality of bells.

The actuator for transferring the striking means into the predefined starting state can be of any desired configuration, for example as a final control element, a motor or a linear drive. Furthermore, any desired type of drive can be used for the actuator, for example an electromagnetic drive, a hydraulic drive, a pneumatic drive and/or a piezoelectric drive. In one embodiment, the actuator is configured such that it can transfer the striking means in a continuous movement or without transient phenomenon into the predefined starting state.

Accordingly, the proposed method can comprise a transfer of the striking means into a predefined starting state by the actuator, said actuator comprising a motor, a linear drive or a final control element, or the actuator being driven electromagnetically, hydraulically, pneumatically or piezoelectrically.

The presented details and exemplary embodiments can be combined with each other as desired.

Different exemplary embodiments of the proposed computer program make it possible to implement the various exemplary embodiments which have been described of the proposed method.

Exemplary embodiments and details of the invention can also be described as follows worded differently:

The method and/or device for providing a sound exciter (=clapper, hammer) in a defined reproducible starting state with respect to a bell, and for actively retrieving the sound exciter after the sound has been excited into the same starting state is characterised in that, by means of a signal derived from the information that a sound excitation is to take place, the sound exciter is initially brought into a defined reproducible starting position by this derived signal which controls, for example electric, magnetic, hydraulic, pneumatic final control elements/motors/actuators, whereupon the actual sound excitation consequently then takes place, the temporal, and otherwise progress of which can optionally be altered/controlled but which results in a desired sound event, and after the sound has been excited by a further signal derived either from the movement of the sound exciter by displacement and/or angle transmitting measuring transducers, from the radiated sound by microphone and/or vibration-detecting transducers, the acoustic vibration of the bell, i.e. of the metal, by means of piezoelectric transducers, magnetic, capacitive-electric and/or optical transducers, or directly from the incoming information for the sound excitation itself, here for example by a time delay, is returned into the starting position by a further active process, facilitated by, for example the same final control elements/motors/actuators as described above.

In other words: a user deliberately generates a signal of any type (electric, hydraulic, pneumatic or mechanical), using which he wants to produce a sound event (=acoustic tone) on a bell via a sound exciter (hammer, clapper). In order for this action to be reproducible in a precise manner and simultaneously for the time delays conditioned by the inertia mainly of the sound exciter to be shortened, by this method and/or device a signal sequence is generated/derived from the user's signal such that the movement of the sound exciter is precisely controlled and can be cleanly reproduced and, compared to the sequence of excitation events known hitherto, takes place faster or even takes place at all, since now configurations of sound exciters are also used which do not have a clear passively defined starting position, for example sound exciters which only move horizontally on a sliding rail, or for example those which rotate about their centre of mass. For this purpose, it is necessary to provide this clearly defined starting position of the sound exciter relative to the bell in an active manner after the user has announced his intention by his signal, but before the actual sound event. In order that the user can initiate a further sound event in the shortest possible time after a preceding sound event, this method and/or device intervenes in the course of movements of the sound generator such that the movement phases of the sound exciter which have nothing to do with the actual sound excitation event are accelerated via the impression of external forces (by means of the electromagnetic, hydraulic, pneumatic or piezoelectric actuator). And since this method and/or device is also concerned with the shortening of time lapses, a possibility exists for this in permanently controlling the starting state of the sound exciter.

Therefore, the method and/or device is alternately characterised in that the exciter is kept permanently and actively in its starting state and in that by the signal, the information for sonic excitement, this now active holding state for the excitation procedure is lifted in order to be actively returned into the starting position after the excitation procedure, as described above, and to then return into the permanently and actively held starting state. This also has the advantage, inter alia, that a further configuration of actuators can be used, namely the actuators which, as a condition of their construction, rest against the bell in their passive idle position, which usually opposes a sound excitation process at the bell. For example a sound exciter on an inclined sliding path. In this case, the sound exciter, conditioned by gravity, rests against the bell and must firstly be moved away.

The exciter can be provided in an active and permanent manner in the starting state, for example by sensors (switches, light barriers, pressure measuring devices, optical or mechanical displacement pickups and angle transducers) which detect the position of the exciter independently of an excitation process and then transfer the exciter into the desired starting state by positioning devices (for example electromagnetic, hydraulic or pneumatic servomotors or linear drives) and keep it there.

This method and/or device relates, as previously expressed, to a respective individual sound event at a bell, although intentional sound sequences can be produced by linking together a plurality of events, for example the sound impression of chimes or the striking of a bell in a carillon, thus in connection with other bells.

The advantage of this method and/or device is on the one hand having the same starting conditions for each individual strike of the sound exciter and on the other hand arriving at a presentation which is accelerated compared to the passive process (gravity, spring, rubber band, magnet) of the starting state by the active restoring process. This has the advantage of being ready more quickly for a further sound excitation. In this respect, one and the same actuator (one and the same positioning device) can be used for both partial procedures for the presentation of the method and/or device.

In previous excitations of bells, to the best of my knowledge it has not been necessary to use an intentional active control or a better presentation of a movement starting point of the exciter, as there was no requirement for a fast movement to the starting point/rest point. However, the use of exciters which rotate about their centre of mass (for example exciters which have a dumbbell shape with respectively the same weights on the opposing ends of a shaft), and which per se do not have a defined starting position, just like the use of exciters which approach the point of excitement on such a movement path, on which the naturally provided gravity is inadequate in ensuring a passive movement back to a starting/rest position, as in the case of such exciters for which the return is simply not fast enough by gravity or springs or by other passive measures, and just like the use of exciters which, due to their inertia, cannot be brought quickly enough into the starting/rest position by passive means, require the use of the active return and presentation of the starting/rest point by means of the method and/or device put forward here for the active presentation of a defined starting state of a sound exciter at a bell, as well as for the active restoration of the sound exciter into the same starting state after the sound has been excited.

In one embodiment, the method and/or device consists of a processing of the information for excitation such that preceding the signal given by the operator (=user) as a request for excitation is preceded by means of electronic/digital signal processing by the information for controlling the actuator (for example electromagnet, pneumatics, electric motor, piezoelectric final control element) for positioning in the starting state and the excitation information is transferred in a delayed manner and then, after excitation, a further item of information is added thereto for the purpose of an accelerated resetting of the exciter into its starting position.

In a further embodiment, a signal transmitter, for example a switch detects the starting position (which is initially undefined in most cases) of the exciter and then generates a positioning signal which is asynchronous with the course of the excitation and which moves the exciter into its starting position. This positioning signal is interrupted in any event by an excitation signal and is directly reconnected after the signal for accelerated return, which is a component of the sequence described above.

The signal processing operations and controls which have been described can be carried out by a hardware circuit and/or by a computer program, executed by a processor.

In the following, the invention is described in more detail with reference to an exemplary embodiment.

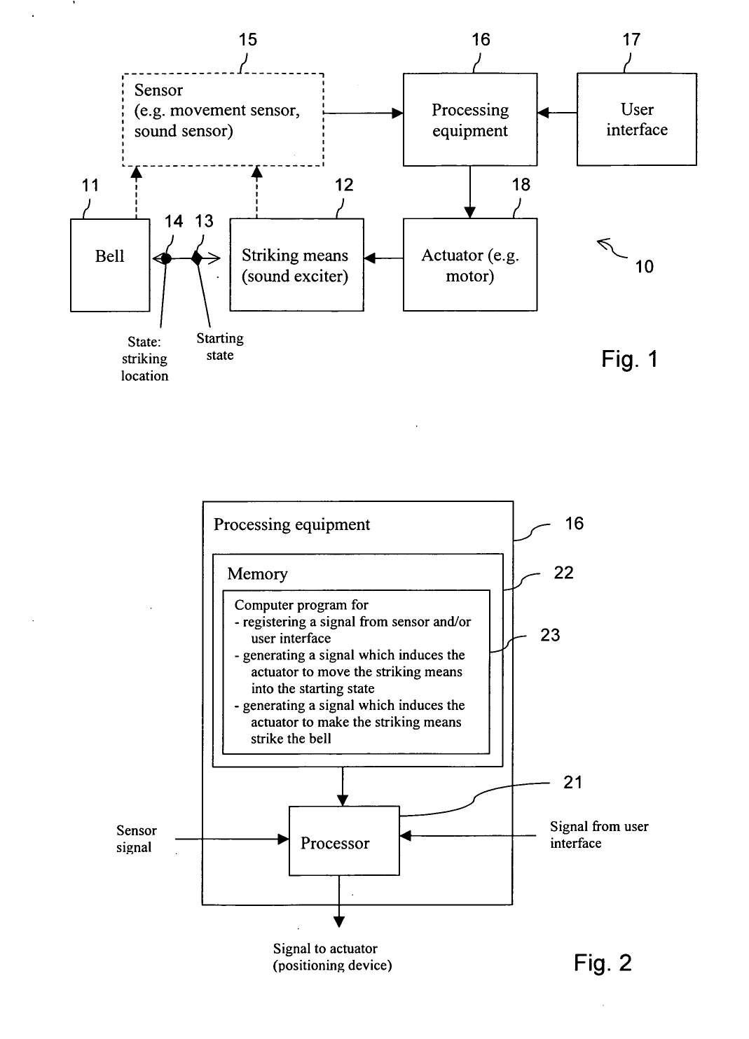

FIG. 1 shows a block diagram of an exemplary embodiment of a device according to the invention;

FIG. 2 shows an exemplary, schematically illustrated configuration of a component of the device of FIG. 1;

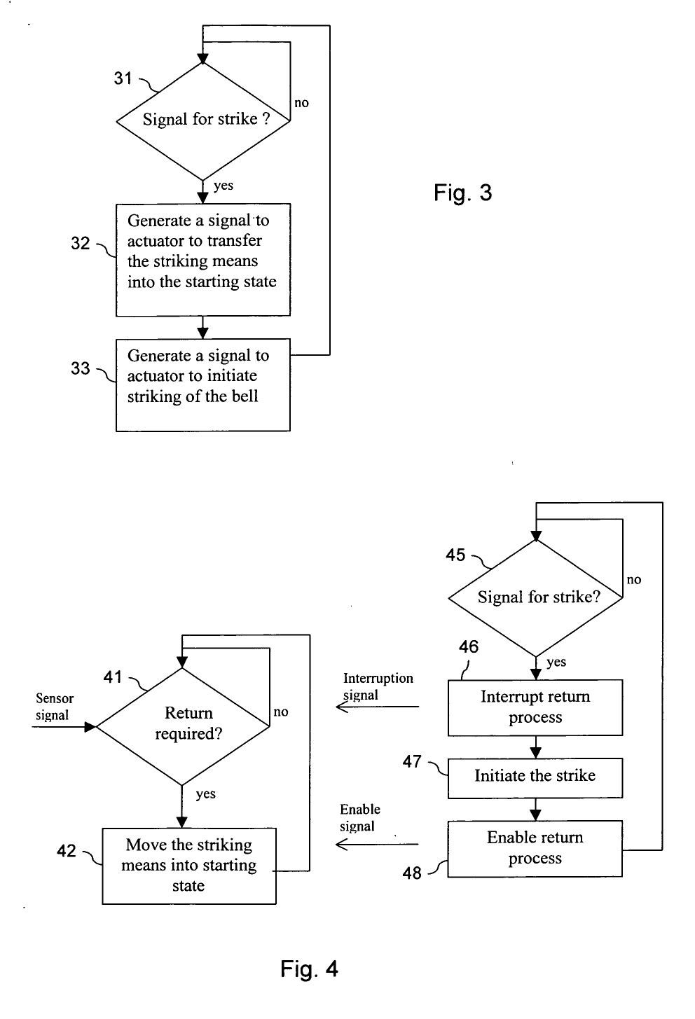

FIG. 3 shows a flow chart illustrating a first exemplary embodiment of a method according to the invention; and

FIG. 4 shows a flow chart illustrating a second exemplary embodiment of a method according to the invention.

FIG. 1 shows a schematic block diagram of an exemplary embodiment of a device 10 according to the invention.

The device 10 comprises a bell 11 and a striking means 12 for striking the bell 11. The striking means 12 can be any desired sound exciter, for example a clapper, a hammer or a dumbbell-shaped exciter. The striking means 12 can be moved spatially between different states, which is indicated by a double-headed arrow. A clapper could be suspended from one end, for example, and could be deflected around this fixed point to strike the bell. A hammer could be moved backwards and forwards on a sliding rail, for example, to strike the bell. A dumbbell-shaped striking means could rotate about a rotation point, for example, to strike the bell. Previously defined for the striking means 12 is a spatial starting state 13 in which the striking means 12 occupies a specific position, situation or orientation relative to the bell 11. The defined starting state 13 differs spatially from a state 14 in which the striking means 12 comes into contact with the bell 11 in a striking location in order to excite the bell 11 into vibration.

The device 10 optionally further comprises at least one sensor 15 which monitors the bell 11 and/or the striking means 12. The sensor 13 can be any desired sensor capable of generating a signal which provides a direct or indirect indication whether the striking means 12 is deviating from the predefined starting state 13. A sound sensor can detect, for example, that the bell 11 has been struck and that the striking means 12 has thus left the starting state. A mechanical or optical movement sensor can detect, for example, whether the striking means 12 has moved. The signal generated by the sensor 15 can be any type of signal, for example electrical, optical or mechanical.

The device 10 further comprises processing equipment 16, a user interface 17 and an actuator 18. The processing equipment 16 is connected to the sensor 15, the user interface 17 and the actuator 18. In this respect, the term “connected” is not necessarily understood in the sense of a physical connection. It can also simply be possible for optical signals or radio signals to be sent from one of the components to another component. The actuator 18 is also connected to the striking means 12.

The actuator 18 can be a positioning device of any desired configuration for actively moving the striking means 12. Examples include an electromagnetic, hydraulic or pneumatic motor or linear drive. The actuator 18 can be configured to transfer the striking means 12 into the state 14 in which it strikes the bell 11 in the striking location and also to transfer the striking means 12 into the defined starting state 13. Alternatively however, the actuator 18 can also be configured to only transfer the striking means 12 into the defined starting state 13. A further actuator which is not shown separately can then be provided for moving the striking means 12 such that it strikes the bell 11.

The user interface 17 can be any means which allows a user to cause the output of a signal which is to induce the striking of the bell 11. A possible example is a keyboard-like device in which the bell 11 is associated with a specific key which, when actuated, results in the output of a specific signal. Also possible here is a unit which allows stored data to be read which is then forwarded as signals to the processing equipment 16 at specific times on a start command by the user or automatically. If the device 10 comprises a single bell 11, the user interface 17 can then also substantially consist of a single key, an actuation of which results in the output of a signal. It is understood that the user interface 17 can output any type of signal, for example an electrical signal, an optical signal or a mechanical signal. In the latter case, the user could, for example, expend a force, such as pulling a cord, actuating a manual appliance or a pedal to set a toothed wheel into rotation or to start a piston moving. The movement of the toothed wheel or piston can then be understood as a signal generated by the user interface 17.

The processing equipment 16 converts registered signals from the user interface 17 and optionally from the sensor 15 into a signal at the actuator 18.

The processing equipment 16 can be a purely mechanical means which converts registered mechanical signals into mechanical output signals. For example, a rotation, induced by the user interface 17, of a toothed wheel could be converted into the rotation of further toothed wheels. One possibility for the processing of electrical or optical signals is a pure hardware circuit which, for example, registers incoming signals by means of comparators and outputs signals to the actuator 18 by means of electronic switches. Furthermore, the processing equipment 16 could also be configured on a software basis. Finally, a mixed form of these configurations is also considered.

An exemplary configuration of processing equipment 16 based on software is shown schematically in FIG. 2.

In this case, the processing equipment 16 comprises a processor 21 and a memory 22 as a computer program product. The memory 22 comprises any desired computer-readable medium which stores a computer program 23. The computer program 23 can be read out and executed by the processor 21. The computer program 23 then for example induces the processor 21 to register a signal from the user interface 17 or from the sensor 15, to generate a signal which induces the actuator 18 to move the striking means 12 into the starting state 13 and to generate a signal which induces the actuator 18 to make the striking means 12 strike the bell 11.

The device 10 can also be a carillon with a plurality of bells, in which case separate striking means, sensors and actuators can be provided for each of the bells. However, depending on the type of sensor, a common sensor can also be used. User interface 17 and processing equipment 16 can be used jointly for all the bells.

Exemplary modes of operation of the device 10 of FIG. 1 will now be described in detail with reference to FIGS. 3 and 4.

FIG. 3 shows a control circuit in the form of a flow chart. The flow chart illustrates a first exemplary embodiment of a method according to the invention. A sensor 15 is not required for this exemplary embodiment.

The processing equipment 16 monitors whether it is registering a signal from the user interface 17 (action 31). A signal from the user interface 17 indicates that a user would like the bell 11 to be struck.

As soon as a signal from the user interface 17 is registered, the processing equipment 16 generates a first signal to the actuator 18 (action 32). This signal induces the actuator 18 to transfer the striking means 12 into the predefined starting state 13.

Thereafter, after a short predetermined time lapse, the processing equipment 16 generates a second signal at the actuator 18 (action 33). This signal induces the actuator 18 to transfer the striking means 12 into the state 14 in which it strikes the bell 11 in the striking location.

Finally, in a loop, the processing equipment 16 continues to monitor whether it is registering a further signal from the user interface 17 (action 31).

In a variation of this control circuit, action 32 can also depend in addition on a sensor signal which indicates whether the striking means 12 is already in the predefined starting state 13. Thus, for example a light barrier of an optical sensor can be interrupted as long as the striking means 12 is in the predefined starting state 13. In this case, it is possible to omit action 32. However, if the striking means 12 is not in the predefined starting state 13, a light signal is registered, is forwarded to the processing equipment 16 and action 32 is carried out.

If the predefined starting state 13 is a stable state for the striking means 12, the sequence of actions 32 and 33 can also be interchanged in a further variation of the control circuit of FIG. 3. In this case, it could also be entirely dependent on a signal from sensor 15 when exactly action 32 is carried out. If sensor 15 is a sound sensor for example, action 32 can be carried out whenever a sound is registered, after the bell 11 has been struck, and a corresponding signal is sent to the processing equipment 16.

FIG. 4 shows a flow chart which illustrates a second exemplary embodiment of a method according to the invention. The sensor 15 is provided in any event for this exemplary embodiment.

The flow chart comprises two control circuits. Both control circuits are operated asynchronously and parallel to one another by the processing equipment 16.

According to the first control circuit shown on the left-hand side, the processing equipment 16 continuously checks whether the striking means 12 is in the defined starting state 13 (action 41).

The check is made using a signal from sensor 15 which provides corresponding information. An optical or mechanical angle transducer as sensor 15 could check, for example whether a current deflection of the striking means 12 corresponds to a deflection which would be required for the defined starting state 13.

If the signal from sensor 15 indicates that the striking means 12 is currently not in the defined starting state 13, the processing equipment 16 generates a signal to the actuator 18. This signal induces the actuator 18 to transfer the striking means 12 into the defined starting state 13 (action 42).

According to the second control circuit shown on the right-hand side, the processing equipment 16 continuously checks whether the user interface 17 is producing a signal which indicates that the user wants the bell 11 to be struck (action 45).

As soon as such a signal is registered, the processing equipment 16 interrupts the first control circuit (action 46). In the case of a hardware circuit, this can be performed for example by an interruption signal which actuates a switch. In the case of a software-based configuration, this can be carried out, for example, by means of an interrupt from a process implementing the second control circuit to a process implementing the first control circuit which stops this process.

The processing equipment 16 then induces the actuator 18 by a signal to initiate the striking of the bell 11 by the striking means 12 (action 47).

After a predetermined short period of time after the signal has been output to actuator 18 for the striking, the first control circuit is enabled again for the return process (action 48). If the processing equipment 16 is realised by a hardware circuit, this can be carried out for example by means of an enable signal which actuates a switch. In the case of a software-based configuration of the processing equipment 16, this can be carried out for example by means of a renewed call up of the process implementing the first control circuit.

It is understood that the embodiments which have been described are merely examples which can be modified and/or supplemented in many different ways within the scope of the claims.

1. A method for controlling a sound exciter for a bell, comprising in this order at processing equipment:
a) registering a signal for inducing a single sound event, a signal for inducing a single sound event being a respective signal that is individually caused by a user or a data processing entity;
b) inducing an actuator by means of a signal generated following the registered signal to transfer the sound exciter into a predefined starting state, when an additionally registered sensor signal indicates that the sound exciter is not in the predefined starting state;
c) inducing a striking of the bell by means of the sound exciter;
d) inducing a retrieval of the sound exciter into the predefined starting state; and
e) continuing with step a), if a further signal for inducing a single sound event is caused by a user or a data processing entity.

2. (canceled)

3. (canceled)

4. (canceled)

5. (canceled)

6. The method according to claim 1, further comprising:
transferring the sound exciter into a predefined starting state by the actuator, said actuator comprising a motor, a linear drive or a final control element.

7. The method according to claim 1, further comprising:
transferring the sound exciter into a predefined starting state by the actuator, said actuator being driven electromagnetically, hydraulically, pneumatically or piezoelectrically.

8. A device comprising processing equipment, the processing equipment configured to
a) register a signal for inducing a single sound event, a signal for inducing a single sound event being a respective signal that is individually caused by a user or a data processing entity, and
b) induce an actuator, by a signal generated following the registered signal, to transfer a sound exciter for a bell into a predefined starting state, when an additionally registered sensor signal indicates that the sound exciter is not in the predefined starting state;
c) inducing a striking of the bell by means of the sound exciter;
d) inducing a retrieval of the sound exciter into the predefined starting state; and
e) continuing with a), if a further signal for inducing a single sound event is caused by a user or a data processing entity.

9. (canceled)

10. (canceled)

11. The device according to claim 8, wherein the device further comprises one of the following sensors for outputting a signal at the processing equipment:
an optical displacement pickup;
a mechanical displacement pickup;
an optical angle transducer;
a mechanical angle transducer;
a microphone;
a transducer for detecting vibrations;
a switch;
a light barrier;
a pressure measuring device;
a piezoelectric transducer;
a magnetic sensor;
a capacitive-electrical transducer; and
an optical transducer.

12. (canceled)

13. (canceled)

14. The device according to claim 8, wherein the device comprises at least one of the following components:
the sound exciter;
at least a further sound exciter for at least a further bell;
the bell;
at least a further bell;
the actuator;
at least a further actuator;
a user interface for outputting signals to the processing equipment; and
a sensor for outputting a signal to the processing equipment.

15. The device according to claim 8, wherein the device comprises one of the following actuators for transferring the sound exciter into the predefined starting state:
a motor;
a linear drive; and
a final control element.

16. The device according to claim 8, wherein the device comprises an actuator for transferring the sound exciter into the predefined starting state, which actuator is moved by one of the following drives:
an electromagnetic drive;
a hydraulic drive;
a pneumatic drive; and
a piezoelectric drive.

17. A computer program product comprising a computer-readable medium, in which a computer program for controlling a sound exciter for a bell is stored, wherein the computer program is configured to induce a processor to carry out the following when the computer program is executed by the processor:
a) registering a signal for inducing a single sound event, a signal for inducing a single sound event being a respective signal that is individually caused by a user or a data processing entity;
b) inducing an actuator by means of a signal generated following the registered signal to transfer the sound exciter into a predefined starting state, when an additionally registered sensor signal indicates that the sound exciter is not in the predefined starting state;
c) inducing a striking of the bell by means of the sound exciter;
d) inducing a retrieval of the sound exciter into the predefined starting state; and
e) continuing with step a), if a further signal for inducing a single sound event is caused by a user or a data processing entity.

18. (canceled)

19. The method according to claim 1, wherein the processing equipment comprises a processor, which is caused by a computer program to carry out steps a) to e).

20. The method according to claim 1, which controls the sound exciter for a plurality of bells of a carillon accordingly.

21. The device according to claim 8, wherein the processing equipment comprises a processor and a memory storing a computer program.

22. The device according to claim 8, wherein the processing equipment is configured to control the sound exciter for a plurality of bells of a carillon accordingly.
